(19) United States
(12) Patent Application Publication
(10) Pub. No.: US 2018/0007382 A1
(43) Pub. Date: Jan. 4, 2018

(54) SYSTEMS AND METHODS FOR DETERMINING MOTION VECTORS

(71) Applicant: Facebook, Inc., Menlo Park, CA (US)

(72) Inventor: David Young Joon Pio, Santa Clara, CA (US)

(21) Appl. No.: 15/199,358

(22) Filed: Jun. 30, 2016

(51) Int. Cl. H04N 19/52; H04N 19/172; H04N 19/182; H04N 19/53

(52) U.S. Cl. CPC H04N 19/52; H04N 19/53; H04N 19/172; H04N 19/182

(57) ABSTRACT

Systems, methods, and non-transitory computer-readable media can train a model to predict motion vectors for entities in video frames. A set of frames that correspond to a first video can be obtained. The set of frames can be provided as input to the model. A set of motion vectors for the set of frames can be obtained from the model, wherein each motion vector describes a trajectory of at least one entity in the set of frames.

### FIELD OF THE INVENTION

The present technology relates to the field of determining motion vectors. More particularly, the present technology relates to techniques for determining a motion of objects in images.

### BACKGROUND

Today, people often utilize computing devices (or systems) for a wide variety of purposes. Users can operate their computing devices to, for example, interact with one another, create content, share information, and access information. In some instances, computing devices can be used to determine motion vectors of pixels or objects in frames (e.g., images and/or video frames). Generally, each motion vector describes the motion, or displacement, of objects in a visual scene that is captured in a frame. The motion of objects can be determined, for example, by evaluating the movement of individual pixels between frames. The movement of pixels can be measured based on direction (e.g., movement along the x-axis and y-axis), and magnitude (e.g., the amount the respective pixel was displaced between the frames). Motion vectors can be utilized for various purposes. In one example, motion vectors determined for frames of a video can be utilized to compress the video.

### SUMMARY

Various embodiments of the present disclosure can include systems, methods, and non-transitory computer readable media configured to train a model to predict motion vectors for entities in video frames. A set of frames that correspond to a first video can be obtained. The set of frames can be provided as input to the model. A set of motion vectors for the set of frames can be obtained from the model, wherein each motion vector describes a trajectory of at least one entity in the set of frames.

In an embodiment, an entity is one of a pixel, a block of pixels, an object, or a frame.

In an embodiment, the systems, methods, and non-transitory computer readable media are configured to generate training data to be used for training the model, the training data describing a plurality of entities and their respective pre-computed motion vectors and train the model using the generated training data.

In an embodiment, the systems, methods, and non-transitory computer readable media are configured to obtain a set of videos for training the model, each video having a set of frames, determine a set of respective motion vectors for one or more entities in the set of frames for each video, and cause data describing the one or more entities in the set of frames to be included in the training data as an example inputs and the corresponding motion vectors for the entities to be included in the training data as example outputs.

In an embodiment, the set of motion vectors are optimally determined using an exhaustive motion estimation algorithm.

In an embodiment, the systems, methods, and non-transitory computer readable media are configured to obtain a set of videos for training the model, each video having a set of frames, identify one or more objects in the set of frames for each video, determine a set of respective motion vectors for the one or more objects, and cause data describing the one or more objects in the set of frames to be included in the training data as an example inputs and the corresponding motion vectors for the objects to be included in the training data as example outputs.

In an embodiment, the systems, methods, and non-transitory computer readable media are configured to provide data describing one or more of the entities included in the training data as input to the model, obtain one or more respective motion vectors for the entities from the model, and determine an inaccuracy in a motion vector determined by the model for at least one entity based at least in part on the respective pre-computed motion vector of the entity.

In an embodiment, the systems, methods, and non-transitory computer readable media are configured to cause the model to be retrained based at least in part on the inaccuracy.

In an embodiment, the entities correspond to frames, and wherein the motion vectors provide a general motion estimation of one or more frames.

In an embodiment, the systems, methods, and non-transitory computer readable media are configured to provide the general motion estimation to at least one motion estimation algorithm, wherein the motion estimation algorithm is configured to determine one or more motion vectors for the entities based at least in part on the general motion estimation.

It should be appreciated that many other features, applications, embodiments, and/or variations of the disclosed technology will be apparent from the accompanying drawings and from the following detailed description. Additional and/or alternative implementations of the structures, systems, non-transitory computer readable media, and methods described herein can be employed without departing from the principles of the disclosed technology.

### BRIEF DESCRIPTION OF THE DRAWINGS

FIG. 1 illustrates an example system including an example motion estimation module configured to determine motion vectors for video content using one or more trained machine learning models, according to an embodiment of the present disclosure.

FIG. 2 illustrates an example motion vector model module configured to analyze video content to determine motion vectors, according to an embodiment of the present disclosure.

FIG. 3 illustrates an example training data module configured to generate training sets, according to an embodiment of the present disclosure.

FIG. 4 illustrates an example diagram illustrating a trained model for determining motion vectors, according to various embodiments of the present disclosure.

FIG. 5 illustrates an example process for training a model to determine motion vectors, according to various embodiments of the present disclosure.

FIG. 6 illustrates a network diagram of an example system including an example social networking system that can be utilized in various scenarios, according to an embodiment of the present disclosure.

FIG. 7 illustrates an example of a computer system or computing device that can be utilized in various scenarios, according to an embodiment of the present disclosure.

The figures depict various embodiments of the disclosed technology for purposes of illustration only, wherein the figures use like reference numerals to identify like elements. One skilled in the art will readily recognize from the following discussion that alternative embodiments of the structures and methods illustrated in the figures can be employed without departing from the principles of the disclosed technology described herein.

### DETAILED DESCRIPTION

### Approaches for Determining Motion Vectors

People use computing devices (or systems) for a wide variety of purposes. As mentioned, computing devices can be used for motion estimation of videos. In general, motion estimation involves the process of determining, from a set of frames (e.g., images and/or video frames), a set of motion vectors that correspond to various entities in the frames. A motion vector can describe the motion, or displacement, of an entity in the set of frames. An entity can refer to a pixel in a frame, a block (e.g., a block of pixels or macroblock) in a frame, an object identified in a visual scene captured by a frame, or the frame itself. The respective motions of entities can be determined, for example, by evaluating the displacement of the entities in the frames. The displacement of entities can be measured, for example, based on direction (e.g., movement along the x-axis, y-axis, and/or z-axis) and magnitude (e.g., the amount the respective entity was displaced, for example, between the frames). Existing approaches for determining motion vectors can provide accurate measurements, however, such approaches are typically computationally expensive. Alternatively, other existing approaches can be computationally inexpensive but typically provide less accurate motion vector measurements. Accordingly, such conventional approaches may not be effective in addressing these and other problems arising in computer technology.

An improved approach rooted in computer technology overcomes the foregoing and other disadvantages associated with conventional approaches specifically arising in the realm of computer technology. In various embodiments, a set of frames can be provided as input to a trained model to obtain a corresponding set of motion vectors for various entities. Depending on the implementation, the model can be trained to predict motion vectors for entities such as one or more pixels, blocks, objects, or the frames themselves. In various embodiments, the model can be trained using ground truth motion vector training data that may be generated from a set of videos, as described herein. Once trained, the model can determine, for a set of frames, a corresponding set of motion vectors that measure the respective displacements of entities corresponding to the frames. As mentioned, in some embodiments, the model can be trained to predict motion vectors for objects that are identified in visual scenes captured by the frames. In such embodiments, the model can be trained to recognize objects (e.g., human faces, physical objects, people, plants, buildings, lines, blobs, edges, surfaces, etc.) and to predict motion vectors for such objects that appear both within and between the set of frames.

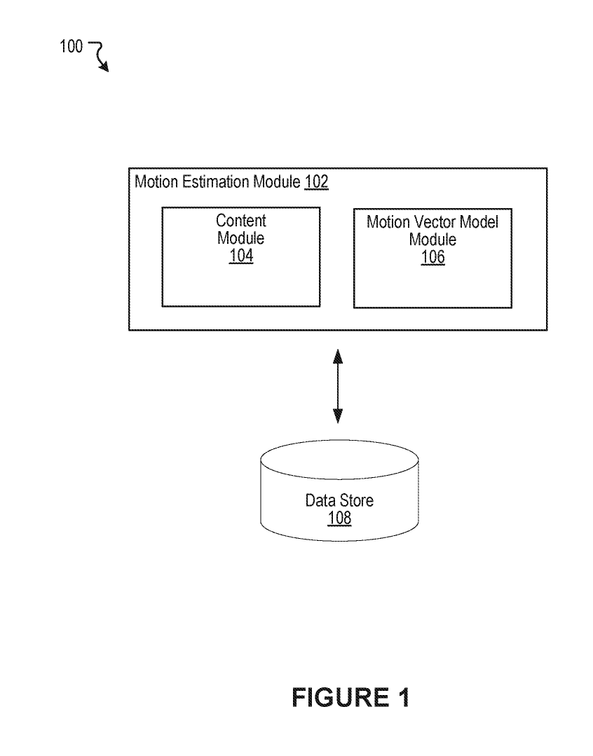

FIG. 1 illustrates an example system including an example motion estimation module 102 configured to determine motion vectors for video content using one or more trained machine learning models, according to an embodiment of the present disclosure. As shown in the example of FIG. 1, the example motion estimation module 102 can include a content module 104 and a motion vector model module 106. In some instances, the example system 100 can include at least one data store 108. The components (e.g., modules, elements, etc.) shown in this figure and all figures herein are exemplary only, and other implementations may include additional, fewer, integrated, or different components. Some components may not be shown so as not to obscure relevant details.

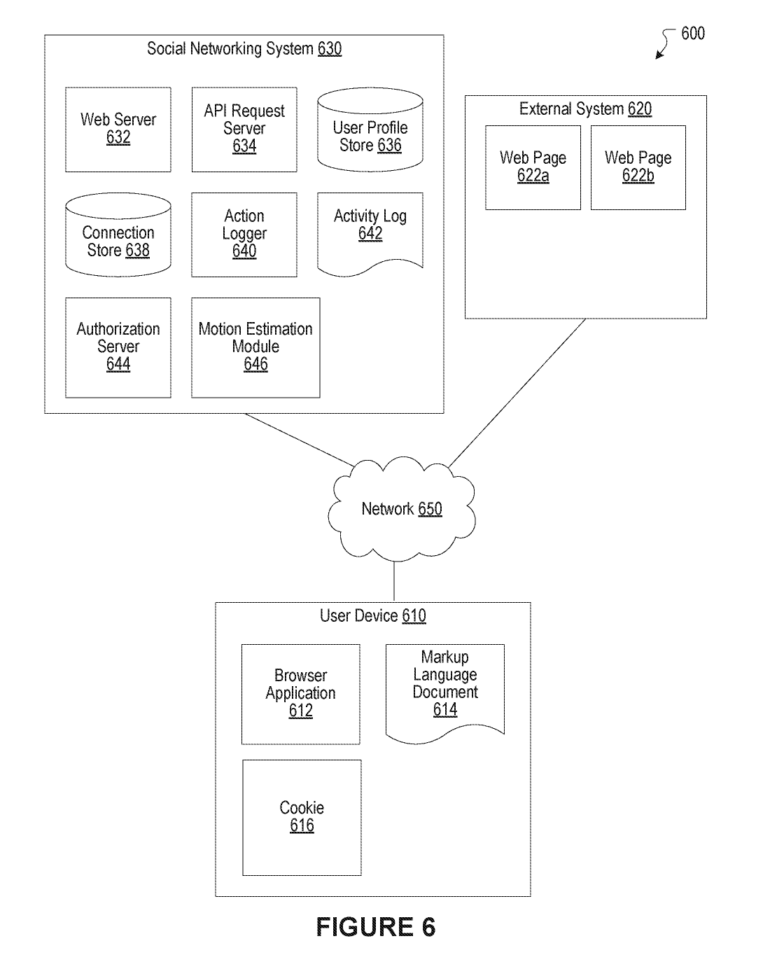

In some embodiments, the motion estimation module 102 can be implemented, in part or in whole, as software, hardware, or any combination thereof. In general, a module as discussed herein can be associated with software, hardware, or any combination thereof. In some implementations, one or more functions, tasks, and/or operations of modules can be carried out or performed by software routines, software processes, hardware, and/or any combination thereof. In some cases, the motion estimation module 102 can be implemented, in part or in whole, as software running on one or more computing devices or systems, such as on a user or client computing device. In one example, the motion estimation module 102 or at least a portion thereof can be implemented as or within an application (e.g., app), a program, or an applet, etc., running on a user computing device or a client computing system, such as the user device 610 of FIG. 6. In another example, the motion estimation module 102 or at least a portion thereof can be implemented using one or more computing devices or systems that include one or more servers, such as network servers or cloud servers. In some instances, the motion estimation module 102 can, in part or in whole, be implemented within or configured to operate in conjunction with a social networking system (or service), such as the social networking system 630 of FIG. 6.

The motion estimation module 102 can be configured to communicate and/or operate with the at least one data store 108, as shown in the example system 100. The at least one data store 108 can be configured to store and maintain various types of data. In some implementations, the at least one data store 108 can store information associated with the social networking system (e.g., the social networking system 630 of FIG. 6). The information associated with the social networking system can include data about users, social connections, social interactions, locations, geo-fenced areas, maps, places, events, pages, groups, posts, communications, content, feeds, account settings, privacy settings, a social graph, and various other types of data. In some implementations, the at least one data store 108 can store information associated with users, such as user identifiers, user information, profile information, user specified settings, content produced or posted by users, and various other types of user data. In some embodiments, the at least one data store 108 can store media content including video content, which can be obtained by the motion estimation module 102. In some instances, the at least one data store 108 can also store training data for training one or more machine learning models to predict motion vectors for a set of frames or videos. In one example, the training data can include, for example, one or more ground truth motion vector data sets that can be used to train a machine learning model for predicting motion vectors for a set of frames, such as respective directions and magnitudes for entities corresponding to the set of frames. This training data may be real data with a known ground truth, artificial data whose ground truth has been determined using an existing motion estimation technique, and/or hand labeled motion vector data sets. It should be appreciated that many variations are possible.

The content module 104 can be configured to obtain and/or receive video content to be analyzed. The video content may be a set of images or video frames, or video files, for example. In various embodiments, the video content may be provided (e.g., uploaded) by users of a social networking system and/or a content provider. In some embodiments, such video content may be stored in the data store 108 and the content module 104 can be configured to obtain the video content from the data store 108. In some instances, such content items can be used to train a model, as described below.

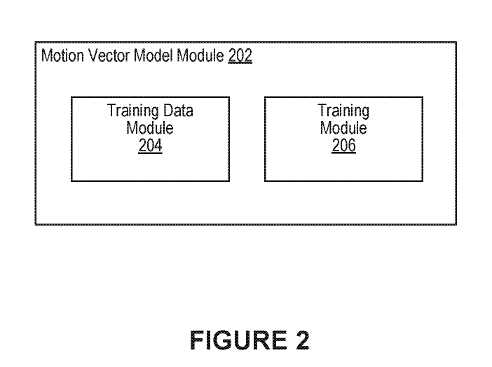

The motion vector module 106 can be configured to analyze video content, such as video content provided by the content module 104. In various embodiments, the motion vector module 106 can evaluate the video content using one or more trained models that have each been configured to determine motion vectors of entities within frames and/or between a set of frames (e.g., a frame t and a frame t+n or frame t and a frame t−n) in the video content. More details regarding the motion vector module 106 will be provided below with reference to FIG. 2.

FIG. 2 illustrates an example motion vector model module 202 configured to analyze video content to determine motion vectors, according to an embodiment of the present disclosure. In some embodiments, the motion vector module 106 of FIG. 1 can be implemented as the example motion vector module 202. As shown in FIG. 2, the example motion vector model module 202 includes a training data module 204 and a training module 206. The motion vector model module 202 can evaluate a set of frames in a video using a trained model to determine motion vectors for entities within and/or between the set of frames. In various embodiments, the model can be implemented using any number of generally known machine learning techniques.

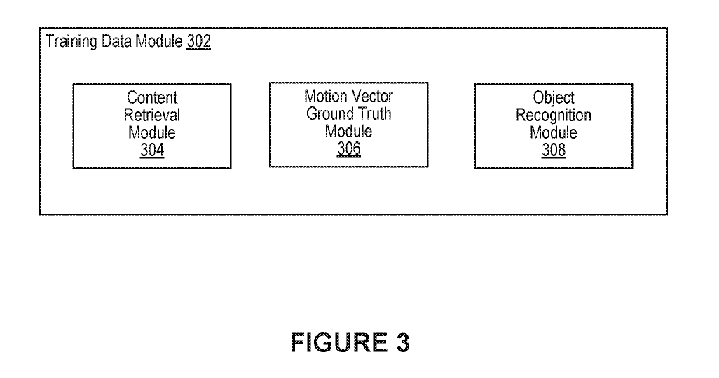

The training data module 204 can be configured to generate training sets to be used for training a model to determine motion vectors for a set of frames. More details regarding the training data module 204 will be provided below with reference to FIG. 3.

The training module 206 can be configured to train the model to output, or predict, motion vectors for a set of frames. In various embodiments, the trained model can receive, as input, a set of frames and can output a set of motion vectors that each correspond to one or more entities. As mentioned, such entities may refer to one or more pixels in the frames, one or more blocks in the frames, one or more objects in the frames, or the individual frames themselves. In some embodiments, the training module 206 can train the model to determine motion vectors using ground truth training data that may be obtained, for example, from a data store (e.g., the data store 108 of FIG. 1). In some embodiments, the training module 206 can train the model to determine motion vectors using ground truth training data that is generated by the training data module 204.

In various embodiments, the model, or classifier, can be implemented using any number of generally known machine learning techniques. In some embodiments, various supervised learning techniques can be applied to train the model. For example, a set training examples to be provided as input to the model can be determined by the training data module 204. Each training example can describe a set of input data and a corresponding desired output (e.g., supervisory signal) for that input data. In various embodiments, a training example can describe an entity and a corresponding motion vector that has been pre-computed for the entity. These pre-computed motion vectors are used as the intended output (e.g., supervisory signal) that the model is being trained to predict. In one example, a training set can be generated for a set of frames (e.g., video). In this example, training examples can be determined for entities in each frame. For example, if the entities correspond to objects, then the training data will include examples that identify objects in each frame as well as the corresponding pre-computed motion vectors that describe an offset, or trajectory, of those objects in the frames. In this example, the model can then be trained using these training examples so that the model can learn how to predict motion vectors that match, or have a threshold level of accuracy, with respect to the pre-computed motion vectors that were included in the training examples.

In some embodiments, during the evaluation phase, the accuracy of the model can be tested, for example, using the motion vectors that were outputted by the model for a set of frames and comparing these predicted motion vectors to the pre-computed motion vectors that were provided to the model during the training phase. As mentioned, a motion vector can describe the respective direction and magnitude of an entity between at least a first frame and a second frame. In this example, the respective magnitude and direction of the entity that was predicted for the entity by the trained model can be compared against the magnitude and direction that was pre-computed for the entity. The training module 206 can measure any inaccuracies in the motion vector information that is outputted by the trained model. In various embodiments, such inaccuracies in the trained model can be reduced using any number of generally known techniques. In one example, the trained model can be implemented as a convolutional neural network. In such embodiments, inaccuracies in the predicted motion vectors can be reduced by performing backpropagation through the convolutional neural network. In general, when reducing such inaccuracies, one or more weight values corresponding to the trained model can be adjusted in order to minimize the inaccuracies. By measuring inaccuracies and refining the model over a number of training iterations, the model can be trained to optimally, or otherwise suitably, predict motion vectors for various types for video content.

FIG. 3 illustrates an example training data module 302 configured to generate training sets, according to an embodiment of the present disclosure. In some embodiments, the training data module 204 of FIG. 2 can be implemented as the example training data module 302. As shown in FIG. 3, the example training data module 302 includes a content retrieval module 304, a motion vector ground truth module 306, and an object recognition module 308.

The content retrieval module 304 can be configured to obtain and/or receive video content items to be used in the training data. The videos may be a set of images or video frames, or video files, for example. In some embodiments, such videos may be stored in a data store (e.g., data store 108) and the content retrieval module 304 can be configured to obtain the video content from the data store.

In some embodiments, each video obtained by the content retrieval module 304 can be analyzed by the motion vector ground truth module 306 to compute a set of motion vectors for the video. For example, the video may include a set of frames. In this example, the motion vector ground truth module 306 can compute a set of motion vectors for entities that correspond to the set of frames. For example, in some embodiments, motion vectors can be determined on a per pixel basis. In this example, for each frame, the motion vector ground truth module 306 can generate a corresponding motion vector for each pixel in the frame. The motion vector can describe an offset, or trajectory, of the pixel, for example, across the set of frames (e.g., a frame t and a frame t+n or frame t and a frame t−n) in the video. The training data module 302 can then include data describing the pixel (e.g., pixel coordinates) and its corresponding motion vector in the training data. In various embodiments, the motion vectors are computed using an exhaustive motion estimation algorithm. These motion vectors are optimally computed so that such pre-computed motion vectors can reliably be used as the ground truth for purposes of training the model. Other implementations are possible. For example, in some embodiments, motion vectors can be determined for some, or all, blocks (e.g., blocks of pixels or macroblock) in each frame. In some embodiments, the motion vectors can be determined on a per-frame basis, for example, for purposes of global motion estimation. In such embodiments, the motion vectors can be used to determine a general motion corresponding to a visual scene represented in a set of frames, such as zooming, panning, rotating, scrolling (e.g., a visual scene that is scrolling from top to bottom, such as end credits in a movie), etc. Such information can be used to optimize motion vector predictions, for example. In some embodiments, the general motion estimations determined for a set of frames can be utilized by a different motion estimation algorithm that is configured to determine motion estimations for individual entities in the frames based at least in part on the general motion estimations predicted for the frames.

In some embodiments, motion vectors can be determined for some, or all, objects in each frame of the video. In such embodiments, the objection recognition module 308 can be configured to apply generally known object recognition techniques to the frames of the videos to identify one or more objects (e.g., human faces, physical objects, people, plants, buildings, lines, blobs, edges, surfaces, etc.). For each object in each frame, the motion vector ground truth module 306 can compute a corresponding motion vector, as described above. The training data module 302 can then include data describing each object (e.g., object identifier, object location, e.g., coordinates, etc.) and its corresponding motion vector in the training data. In such embodiments, the model can be trained to extract features that allow the model to determine the movement of certain types of objects across frames and to utilize such information to predict motion vectors for such objects. In some embodiments, motion vectors can be determined for some, or all, human faces and/or individuals that are identified in video frames. Such human faces and/or individuals may be identified specifically. As a result, true motion can be determined based on how specific faces and/or individuals move in the video frames. For example, rather than determining that some human face moved left by one pixel, the techniques described herein can determine that a particular user moved left by one pixel. This technology is predicated on consent (and privacy settings that allow its use) from any and all users whose faces are being detected and recognized. Users can choose whether or not to opt-in for such technology so that no users are identified without their consent.

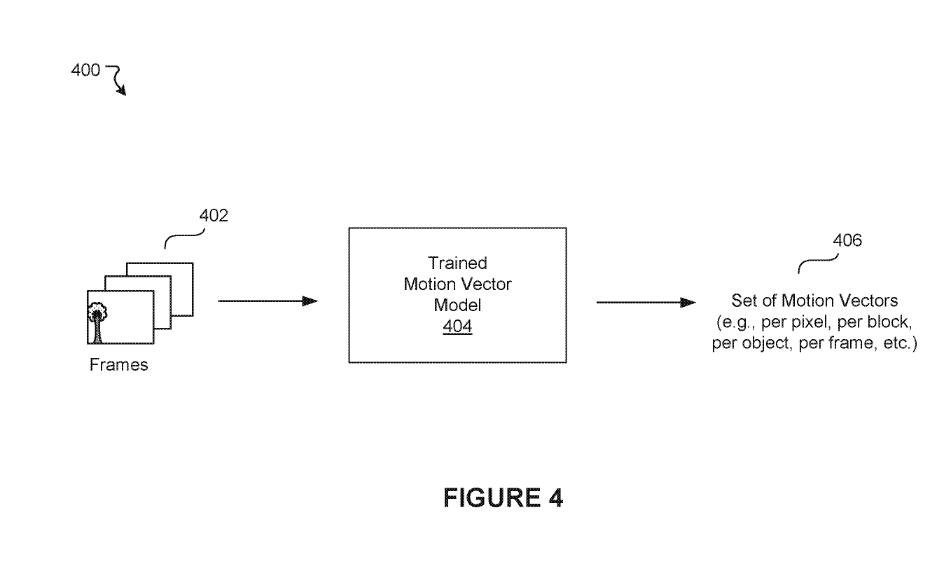

FIG. 4 illustrates an example diagram 400 illustrating a trained model 404 for determining motion vectors, according to various embodiments of the present disclosure. In the example of FIG. 4, the model 404 has been trained to determine, or predict, a set of motion vectors 406 for various entities from a set of input frames 402. In general, a motion vector can describe the motion, or displacement, of an entity. In various embodiments, an entity can refer to a pixel, a block (e.g., block of pixels or macroblock), or an object recognized in a visual scene that is captured in a frame. In some embodiments, the entity can refer to the frame itself. The motion of entities can be determined, for example, by evaluating the displacement of the entities both within and between the set of frames 402. When determining motion vectors on a per-frame basis, the motion of a frame can be determined, for example, by evaluating the displacement of a threshold number of entities in the frame. For example, a motion vector for a frame can be determined by evaluating the motion of some or all pixels in the frame and determining a general direction in which the pixels are moving. In one example, the displacement of entities can be measured, for example, based on direction (e.g., movement along the x-axis, y-axis, and/or z-axis), and magnitude (e.g., the amount the respective entity was displaced, for example, between the frames).

In general, the set of frames 402 can be provided as input to the trained model 404 to obtain the corresponding set of motion vectors 406 for the frames. In various embodiments, the model 404 can be trained using ground truth motion vector training data that can be generated as described above. Once trained, the model 404 can determine, for each inputted frame, a corresponding set of motion vectors that measure the respective displacements of the entities. In some embodiments, the model can be trained to recognize objects. In such embodiments, the model can predict motion vectors for such objects both within and between frames of a video. The set of motion vectors 406 that are outputted by the trained model 404 can be used, for example, to compress the set of frames 402. In some embodiments, the model 404 is implemented as part of an encoding pipeline in which videos are compressed and subsequently posted to a social networking system, for example.

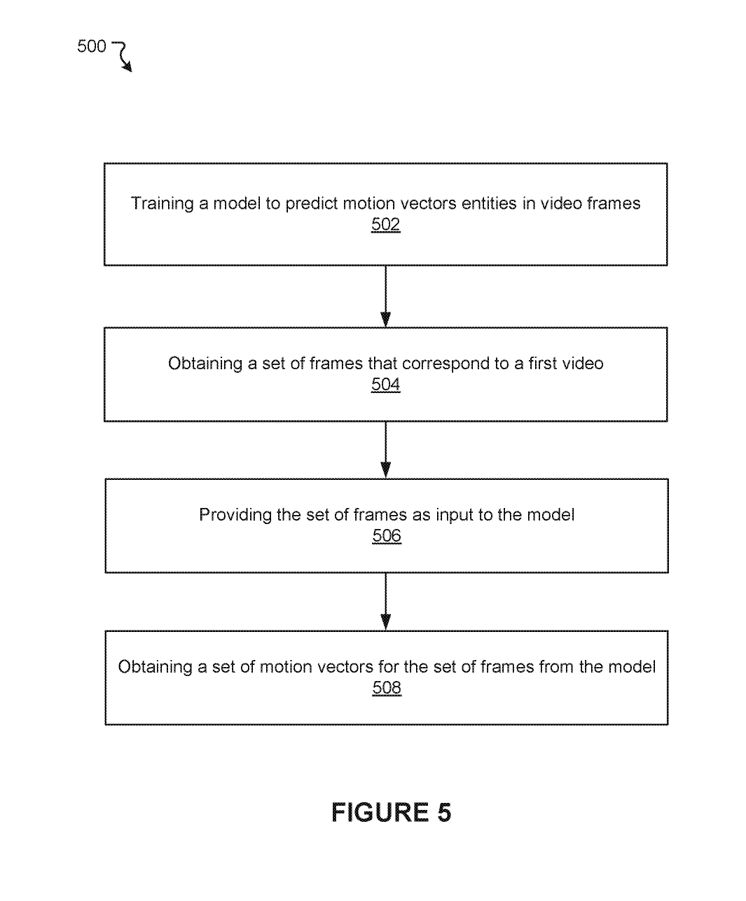

FIG. 5 illustrates an example process 500 for training a model to determine motion vectors, according to various embodiments of the present disclosure. It should be appreciated that there can be additional, fewer, or alternative steps performed in similar or alternative orders, or in parallel, within the scope of the various embodiments discussed herein unless otherwise stated. At block 502, a model to predict motion vectors for entities in video frames is trained. At block 504, a set of frames that correspond to a first video are obtained. At block 506, the set of frames can be provided as input to the model. At block 508, a set of motion vectors for the set of frames can be obtained from the model. Each motion vector can describe a trajectory of at least one entity in the set of frames.

It is contemplated that there can be many other uses, applications, and/or variations associated with the various embodiments of the present disclosure. For example, in some cases, user can choose whether or not to opt-in to utilize the disclosed technology. The disclosed technology can also ensure that various privacy settings and preferences are maintained and can prevent private information from being divulged. In another example, various embodiments of the present disclosure can learn, improve, and/or be refined over time.

### Social Networking System—Example Implementation

FIG. 6 illustrates a network diagram of an example system 600 that can be utilized in various scenarios, in accordance with an embodiment of the present disclosure. The system 600 includes one or more user devices 610, one or more external systems 620, a social networking system (or service) 630, and a network 650. In an embodiment, the social networking service, provider, and/or system discussed in connection with the embodiments described above may be implemented as the social networking system 630. For purposes of illustration, the embodiment of the system 600, shown by FIG. 6, includes a single external system 620 and a single user device 610. However, in other embodiments, the system 600 may include more user devices 610 and/or more external systems 620. In certain embodiments, the social networking system 630 is operated by a social network provider, whereas the external systems 620 are separate from the social networking system 630 in that they may be operated by different entities. In various embodiments, however, the social networking system 630 and the external systems 620 operate in conjunction to provide social networking services to users (or members) of the social networking system 630. In this sense, the social networking system 630 provides a platform or backbone, which other systems, such as external systems 620, may use to provide social networking services and functionalities to users across the Internet.

The user device 610 comprises one or more computing devices (or systems) that can receive input from a user and transmit and receive data via the network 650. In one embodiment, the user device 610 is a conventional computer system executing, for example, a Microsoft Windows compatible operating system (OS), Apple OS X, and/or a Linux distribution. In another embodiment, the user device 610 can be a computing device or a device having computer functionality, such as a smart-phone, a tablet, a personal digital assistant (PDA), a mobile telephone, a laptop computer, a wearable device (e.g., a pair of glasses, a watch, a bracelet, etc.), a camera, an appliance, etc. The user device 610 is configured to communicate via the network 650. The user device 610 can execute an application, for example, a browser application that allows a user of the user device 610 to interact with the social networking system 630. In another embodiment, the user device 610 interacts with the social networking system 630 through an application programming interface (API) provided by the native operating system of the user device 610, such as iOS and ANDROID. The user device 610 is configured to communicate with the external system 620 and the social networking system 630 via the network 650, which may comprise any combination of local area and/or wide area networks, using wired and/or wireless communication systems.

In one embodiment, the network 650 uses standard communications technologies and protocols. Thus, the network 650 can include links using technologies such as Ethernet, 802.11, worldwide interoperability for microwave access (WiMAX), 3G, 4G, CDMA, GSM, LTE, digital subscriber line (DSL), etc. Similarly, the networking protocols used on the network 650 can include multiprotocol label switching (MPLS), transmission control protocol/Internet protocol (TCP/IP), User Datagram Protocol (UDP), hypertext transport protocol (HTTP), simple mail transfer protocol (SMTP), file transfer protocol (FTP), and the like. The data exchanged over the network 650 can be represented using technologies and/or formats including hypertext markup language (HTML) and extensible markup language (XML). In addition, all or some links can be encrypted using conventional encryption technologies such as secure sockets layer (SSL), transport layer security (TLS), and Internet Protocol security (IPsec).

In one embodiment, the user device 610 may display content from the external system 620 and/or from the social networking system 630 by processing a markup language document 614 received from the external system 620 and from the social networking system 630 using a browser application 612. The markup language document 614 identifies content and one or more instructions describing formatting or presentation of the content. By executing the instructions included in the markup language document 614, the browser application 612 displays the identified content using the format or presentation described by the markup language document 614. For example, the markup language document 614 includes instructions for generating and displaying a web page having multiple frames that include text and/or image data retrieved from the external system 620 and the social networking system 630. In various embodiments, the markup language document 614 comprises a data file including extensible markup language (XML) data, extensible hypertext markup language (XHTML) data, or other markup language data. Additionally, the markup language document 614 may include JavaScript Object Notation (JSON) data, JSON with padding (JSONP), and JavaScript data to facilitate data-interchange between the external system 620 and the user device 610. The browser application 612 on the user device 610 may use a JavaScript compiler to decode the markup language document 614.

The markup language document 614 may also include, or link to, applications or application frameworks such as FLASH™ or Unity™ applications, the Silverlight™ application framework, etc.

In one embodiment, the user device 610 also includes one or more cookies 616 including data indicating whether a user of the user device 610 is logged into the social networking system 630, which may enable modification of the data communicated from the social networking system 630 to the user device 610.

The external system 620 includes one or more web servers that include one or more web pages 622a, 622b, which are communicated to the user device 610 using the network 650. The external system 620 is separate from the social networking system 630. For example, the external system 620 is associated with a first domain, while the social networking system 630 is associated with a separate social networking domain. Web pages 622a, 622b, included in the external system 620, comprise markup language documents 614 identifying content and including instructions specifying formatting or presentation of the identified content. As discussed previously, it should be appreciated that there can be many variations or other possibilities.

The social networking system 630 includes one or more computing devices for a social network, including a plurality of users, and providing users of the social network with the ability to communicate and interact with other users of the social network. In some instances, the social network can be represented by a graph, i.e., a data structure including edges and nodes. Other data structures can also be used to represent the social network, including but not limited to databases, objects, classes, meta elements, files, or any other data structure. The social networking system 630 may be administered, managed, or controlled by an operator. The operator of the social networking system 630 may be a human being, an automated application, or a series of applications for managing content, regulating policies, and collecting usage metrics within the social networking system 630. Any type of operator may be used.

Users may join the social networking system 630 and then add connections to any number of other users of the social networking system 630 to whom they desire to be connected. As used herein, the term “friend” refers to any other user of the social networking system 630 to whom a user has formed a connection, association, or relationship via the social networking system 630. For example, in an embodiment, if users in the social networking system 630 are represented as nodes in the social graph, the term “friend” can refer to an edge formed between and directly connecting two user nodes.

Connections may be added explicitly by a user or may be automatically created by the social networking system 630 based on common characteristics of the users (e.g., users who are alumni of the same educational institution). For example, a first user specifically selects a particular other user to be a friend. Connections in the social networking system 630 are usually in both directions, but need not be, so the terms “user” and “friend” depend on the frame of reference. Connections between users of the social networking system 630 are usually bilateral (“two-way”), or “mutual,” but connections may also be unilateral, or “one-way.” For example, if Bob and Joe are both users of the social networking system 630 and connected to each other, Bob and Joe are each other's connections. If, on the other hand, Bob wishes to connect to Joe to view data communicated to the social networking system 630 by Joe, but Joe does not wish to form a mutual connection, a unilateral connection may be established. The connection between users may be a direct connection; however, some embodiments of the social networking system 630 allow the connection to be indirect via one or more levels of connections or degrees of separation.

In addition to establishing and maintaining connections between users and allowing interactions between users, the social networking system 630 provides users with the ability to take actions on various types of items supported by the social networking system 630. These items may include groups or networks (i.e., social networks of people, entities, and concepts) to which users of the social networking system 630 may belong, events or calendar entries in which a user might be interested, computer-based applications that a user may use via the social networking system 630, transactions that allow users to buy or sell items via services provided by or through the social networking system 630, and interactions with advertisements that a user may perform on or off the social networking system 630. These are just a few examples of the items upon which a user may act on the social networking system 630, and many others are possible. A user may interact with anything that is capable of being represented in the social networking system 630 or in the external system 620, separate from the social networking system 630, or coupled to the social networking system 630 via the network 650.

The social networking system 630 is also capable of linking a variety of entities. For example, the social networking system 630 enables users to interact with each other as well as external systems 620 or other entities through an API, a web service, or other communication channels. The social networking system 630 generates and maintains the “social graph” comprising a plurality of nodes interconnected by a plurality of edges. Each node in the social graph may represent an entity that can act on another node and/or that can be acted on by another node. The social graph may include various types of nodes. Examples of types of nodes include users, non-person entities, content items, web pages, groups, activities, messages, concepts, and any other things that can be represented by an object in the social networking system 630. An edge between two nodes in the social graph may represent a particular kind of connection, or association, between the two nodes, which may result from node relationships or from an action that was performed by one of the nodes on the other node. In some cases, the edges between nodes can be weighted. The weight of an edge can represent an attribute associated with the edge, such as a strength of the connection or association between nodes. Different types of edges can be provided with different weights. For example, an edge created when one user “likes” another user may be given one weight, while an edge created when a user befriends another user may be given a different weight.

As an example, when a first user identifies a second user as a friend, an edge in the social graph is generated connecting a node representing the first user and a second node representing the second user. As various nodes relate or interact with each other, the social networking system 630 modifies edges connecting the various nodes to reflect the relationships and interactions.

The social networking system 630 also includes user-generated content, which enhances a user's interactions with the social networking system 630. User-generated content may include anything a user can add, upload, send, or “post” to the social networking system 630. For example, a user communicates posts to the social networking system 630 from a user device 610. Posts may include data such as status updates or other textual data, location information, images such as photos, videos, links, music or other similar data and/or media. Content may also be added to the social networking system 630 by a third party. Content “items” are represented as objects in the social networking system 630. In this way, users of the social networking system 630 are encouraged to communicate with each other by posting text and content items of various types of media through various communication channels. Such communication increases the interaction of users with each other and increases the frequency with which users interact with the social networking system 630.

The social networking system 630 includes a web server 632, an API request server 634, a user profile store 636, a connection store 638, an action logger 640, an activity log 642, and an authorization server 644. In an embodiment of the invention, the social networking system 630 may include additional, fewer, or different components for various applications. Other components, such as network interfaces, security mechanisms, load balancers, failover servers, management and network operations consoles, and the like are not shown so as to not obscure the details of the system.

The user profile store 636 maintains information about user accounts, including biographic, demographic, and other types of descriptive information, such as work experience, educational history, hobbies or preferences, location, and the like that has been declared by users or inferred by the social networking system 630. This information is stored in the user profile store 636 such that each user is uniquely identified. The social networking system 630 also stores data describing one or more connections between different users in the connection store 638. The connection information may indicate users who have similar or common work experience, group memberships, hobbies, or educational history. Additionally, the social networking system 630 includes user-defined connections between different users, allowing users to specify their relationships with other users. For example, user-defined connections allow users to generate relationships with other users that parallel the users' real-life relationships, such as friends, co-workers, partners, and so forth. Users may select from predefined types of connections, or define their own connection types as needed. Connections with other nodes in the social networking system 630, such as non-person entities, buckets, cluster centers, images, interests, pages, external systems, concepts, and the like are also stored in the connection store 638.

The social networking system 630 maintains data about objects with which a user may interact. To maintain this data, the user profile store 636 and the connection store 638 store instances of the corresponding type of objects maintained by the social networking system 630. Each object type has information fields that are suitable for storing information appropriate to the type of object. For example, the user profile store 636 contains data structures with fields suitable for describing a user's account and information related to a user's account. When a new object of a particular type is created, the social networking system 630 initializes a new data structure of the corresponding type, assigns a unique object identifier to it, and begins to add data to the object as needed. This might occur, for example, when a user becomes a user of the social networking system 630, the social networking system 630 generates a new instance of a user profile in the user profile store 636, assigns a unique identifier to the user account, and begins to populate the fields of the user account with information provided by the user.

The connection store 638 includes data structures suitable for describing a user's connections to other users, connections to external systems 620 or connections to other entities. The connection store 638 may also associate a connection type with a user's connections, which may be used in conjunction with the user's privacy setting to regulate access to information about the user. In an embodiment of the invention, the user profile store 636 and the connection store 638 may be implemented as a federated database.

Data stored in the connection store 638, the user profile store 636, and the activity log 642 enables the social networking system 630 to generate the social graph that uses nodes to identify various objects and edges connecting nodes to identify relationships between different objects. For example, if a first user establishes a connection with a second user in the social networking system 630, user accounts of the first user and the second user from the user profile store 636 may act as nodes in the social graph. The connection between the first user and the second user stored by the connection store 638 is an edge between the nodes associated with the first user and the second user. Continuing this example, the second user may then send the first user a message within the social networking system 630. The action of sending the message, which may be stored, is another edge between the two nodes in the social graph representing the first user and the second user. Additionally, the message itself may be identified and included in the social graph as another node connected to the nodes representing the first user and the second user.

In another example, a first user may tag a second user in an image that is maintained by the social networking system 630 (or, alternatively, in an image maintained by another system outside of the social networking system 630). The image may itself be represented as a node in the social networking system 630. This tagging action may create edges between the first user and the second user as well as create an edge between each of the users and the image, which is also a node in the social graph. In yet another example, if a user confirms attending an event, the user and the event are nodes obtained from the user profile store 636, where the attendance of the event is an edge between the nodes that may be retrieved from the activity log 642. By generating and maintaining the social graph, the social networking system 630 includes data describing many different types of objects and the interactions and connections among those objects, providing a rich source of socially relevant information.

The web server 632 links the social networking system 630 to one or more user devices 610 and/or one or more external systems 620 via the network 650. The web server 632 serves web pages, as well as other web-related content, such as Java, JavaScript, Flash, XML, and so forth. The web server 632 may include a mail server or other messaging functionality for receiving and routing messages between the social networking system 630 and one or more user devices 610. The messages can be instant messages, queued messages (e.g., email), text and SMS messages, or any other suitable messaging format.

The API request server 634 allows one or more external systems 620 and user devices 610 to call access information from the social networking system 630 by calling one or more API functions. The API request server 634 may also allow external systems 620 to send information to the social networking system 630 by calling APIs. The external system 620, in one embodiment, sends an API request to the social networking system 630 via the network 650, and the API request server 634 receives the API request. The API request server 634 processes the request by calling an API associated with the API request to generate an appropriate response, which the API request server 634 communicates to the external system 620 via the network 650. For example, responsive to an API request, the API request server 634 collects data associated with a user, such as the user's connections that have logged into the external system 620, and communicates the collected data to the external system 620. In another embodiment, the user device 610 communicates with the social networking system 630 via APIs in the same manner as external systems 620.

The action logger 640 is capable of receiving communications from the web server 632 about user actions on and/or off the social networking system 630. The action logger 640 populates the activity log 642 with information about user actions, enabling the social networking system 630 to discover various actions taken by its users within the social networking system 630 and outside of the social networking system 630. Any action that a particular user takes with respect to another node on the social networking system 630 may be associated with each user's account, through information maintained in the activity log 642 or in a similar database or other data repository. Examples of actions taken by a user within the social networking system 630 that are identified and stored may include, for example, adding a connection to another user, sending a message to another user, reading a message from another user, viewing content associated with another user, attending an event posted by another user, posting an image, attempting to post an image, or other actions interacting with another user or another object. When a user takes an action within the social networking system 630, the action is recorded in the activity log 642. In one embodiment, the social networking system 630 maintains the activity log 642 as a database of entries. When an action is taken within the social networking system 630, an entry for the action is added to the activity log 642. The activity log 642 may be referred to as an action log.

Additionally, user actions may be associated with concepts and actions that occur within an entity outside of the social networking system 630, such as an external system 620 that is separate from the social networking system 630. For example, the action logger 640 may receive data describing a user's interaction with an external system 620 from the web server 632. In this example, the external system 620 reports a user's interaction according to structured actions and objects in the social graph.

Other examples of actions where a user interacts with an external system 620 include a user expressing an interest in an external system 620 or another entity, a user posting a comment to the social networking system 630 that discusses an external system 620 or a web page 622a within the external system 620, a user posting to the social networking system 630 a Uniform Resource Locator (URL) or other identifier associated with an external system 620, a user attending an event associated with an external system 620, or any other action by a user that is related to an external system 620. Thus, the activity log 642 may include actions describing interactions between a user of the social networking system 630 and an external system 620 that is separate from the social networking system 630.

The authorization server 644 enforces one or more privacy settings of the users of the social networking system 630. A privacy setting of a user determines how particular information associated with a user can be shared. The privacy setting comprises the specification of particular information associated with a user and the specification of the entity or entities with whom the information can be shared. Examples of entities with which information can be shared may include other users, applications, external systems 620, or any entity that can potentially access the information. The information that can be shared by a user comprises user account information, such as profile photos, phone numbers associated with the user, user's connections, actions taken by the user such as adding a connection, changing user profile information, and the like.

The privacy setting specification may be provided at different levels of granularity. For example, the privacy setting may identify specific information to be shared with other users; the privacy setting identifies a work phone number or a specific set of related information, such as, personal information including profile photo, home phone number, and status. Alternatively, the privacy setting may apply to all the information associated with the user. The specification of the set of entities that can access particular information can also be specified at various levels of granularity. Various sets of entities with which information can be shared may include, for example, all friends of the user, all friends of friends, all applications, or all external systems 620. One embodiment allows the specification of the set of entities to comprise an enumeration of entities. For example, the user may provide a list of external systems 620 that are allowed to access certain information. Another embodiment allows the specification to comprise a set of entities along with exceptions that are not allowed to access the information. For example, a user may allow all external systems 620 to access the user's work information, but specify a list of external systems 620 that are not allowed to access the work information. Certain embodiments call the list of exceptions that are not allowed to access certain information a “block list”. External systems 620 belonging to a block list specified by a user are blocked from accessing the information specified in the privacy setting. Various combinations of granularity of specification of information, and granularity of specification of entities, with which information is shared are possible. For example, all personal information may be shared with friends whereas all work information may be shared with friends of friends.

The authorization server 644 contains logic to determine if certain information associated with a user can be accessed by a user's friends, external systems 620, and/or other applications and entities. The external system 620 may need authorization from the authorization server 644 to access the user's more private and sensitive information, such as the user's work phone number. Based on the user's privacy settings, the authorization server 644 determines if another user, the external system 620, an application, or another entity is allowed to access information associated with the user, including information about actions taken by the user.

In some embodiments, the social networking system 630 can include an motion estimation module 646. The motion estimation module 646 can, for example, be implemented as the motion estimation module 102 of FIG. 1. As discussed previously, it should be appreciated that there can be many variations or other possibilities.

### Hardware Implementation

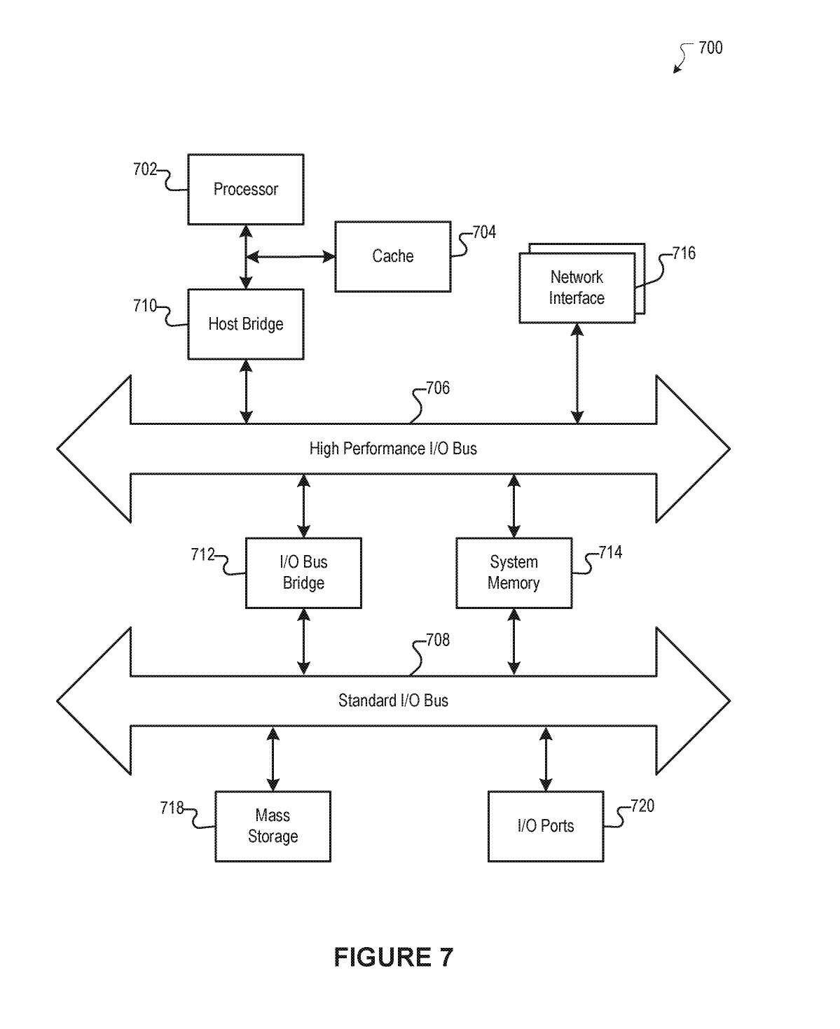

The foregoing processes and features can be implemented by a wide variety of machine and computer system architectures and in a wide variety of network and computing environments. FIG. 7 illustrates an example of a computer system 700 that may be used to implement one or more of the embodiments described herein in accordance with an embodiment of the invention. The computer system 700 includes sets of instructions for causing the computer system 700 to perform the processes and features discussed herein. The computer system 700 may be connected (e.g., networked) to other machines. In a networked deployment, the computer system 700 may operate in the capacity of a server machine or a client machine in a client-server network environment, or as a peer machine in a peer-to-peer (or distributed) network environment. In an embodiment of the invention, the computer system 700 may be the social networking system 630, the user device 610, and the external system 720, or a component thereof. In an embodiment of the invention, the computer system 700 may be one server among many that constitutes all or part of the social networking system 630.

The computer system 700 includes a processor 702, a cache 704, and one or more executable modules and drivers, stored on a computer-readable medium, directed to the processes and features described herein. Additionally, the computer system 700 includes a high performance input/output (I/O) bus 706 and a standard I/O bus 708. A host bridge 710 couples processor 702 to high performance I/O bus 706, whereas I/O bus bridge 712 couples the two buses 706 and 708 to each other. A system memory 714 and one or more network interfaces 716 couple to high performance I/O bus 706. The computer system 700 may further include video memory and a display device coupled to the video memory (not shown). Mass storage 718 and I/O ports 720 couple to the standard I/O bus 708. The computer system 700 may optionally include a keyboard and pointing device, a display device, or other input/output devices (not shown) coupled to the standard I/O bus 708. Collectively, these elements are intended to represent a broad category of computer hardware systems, including but not limited to computer systems based on the x86-compatible processors manufactured by Intel Corporation of Santa Clara, Calif., and the x86-compatible processors manufactured by Advanced Micro Devices (AMD), Inc., of Sunnyvale, Calif., as well as any other suitable processor.

An operating system manages and controls the operation of the computer system 700, including the input and output of data to and from software applications (not shown). The operating system provides an interface between the software applications being executed on the system and the hardware components of the system. Any suitable operating system may be used, such as the LINUX Operating System, the Apple Macintosh Operating System, available from Apple Computer Inc. of Cupertino, Calif., UNIX operating systems, Microsoft® Windows® operating systems, BSD operating systems, and the like. Other implementations are possible.

The elements of the computer system 700 are described in greater detail below. In particular, the network interface 716 provides communication between the computer system 700 and any of a wide range of networks, such as an Ethernet (e.g., IEEE 802.3) network, a backplane, etc. The mass storage 718 provides permanent storage for the data and programming instructions to perform the above-described processes and features implemented by the respective computing systems identified above, whereas the system memory 714 (e.g., DRAM) provides temporary storage for the data and programming instructions when executed by the processor 702. The I/O ports 720 may be one or more serial and/or parallel communication ports that provide communication between additional peripheral devices, which may be coupled to the computer system 700.

The computer system 700 may include a variety of system architectures, and various components of the computer system 700 may be rearranged. For example, the cache 704 may be on-chip with processor 702. Alternatively, the cache 704 and the processor 702 may be packed together as a “processor module”, with processor 702 being referred to as the “processor core”. Furthermore, certain embodiments of the invention may neither require nor include all of the above components. For example, peripheral devices coupled to the standard I/O bus 708 may couple to the high performance I/O bus 706. In addition, in some embodiments, only a single bus may exist, with the components of the computer system 700 being coupled to the single bus. Moreover, the computer system 700 may include additional components, such as additional processors, storage devices, or memories.

In general, the processes and features described herein may be implemented as part of an operating system or a specific application, component, program, object, module, or series of instructions referred to as “programs”. For example, one or more programs may be used to execute specific processes described herein. The programs typically comprise one or more instructions in various memory and storage devices in the computer system 700 that, when read and executed by one or more processors, cause the computer system 700 to perform operations to execute the processes and features described herein. The processes and features described herein may be implemented in software, firmware, hardware (e.g., an application specific integrated circuit), or any combination thereof.

In one implementation, the processes and features described herein are implemented as a series of executable modules run by the computer system 700, individually or collectively in a distributed computing environment. The foregoing modules may be realized by hardware, executable modules stored on a computer-readable medium (or machine-readable medium), or a combination of both. For example, the modules may comprise a plurality or series of instructions to be executed by a processor in a hardware system, such as the processor 702. Initially, the series of instructions may be stored on a storage device, such as the mass storage 718. However, the series of instructions can be stored on any suitable computer readable storage medium. Furthermore, the series of instructions need not be stored locally, and could be received from a remote storage device, such as a server on a network, via the network interface 716. The instructions are copied from the storage device, such as the mass storage 718, into the system memory 714 and then accessed and executed by the processor 702. In various implementations, a module or modules can be executed by a processor or multiple processors in one or multiple locations, such as multiple servers in a parallel processing environment.

Examples of computer-readable media include, but are not limited to, recordable type media such as volatile and non-volatile memory devices; solid state memories; floppy and other removable disks; hard disk drives; magnetic media; optical disks (e.g., Compact Disk Read-Only Memory (CD ROMS), Digital Versatile Disks (DVDs)); other similar non-transitory (or transitory), tangible (or non-tangible) storage medium; or any type of medium suitable for storing, encoding, or carrying a series of instructions for execution by the computer system 700 to perform any one or more of the processes and features described herein.

For purposes of explanation, numerous specific details are set forth in order to provide a thorough understanding of the description. It will be apparent, however, to one skilled in the art that embodiments of the disclosure can be practiced without these specific details. In some instances, modules, structures, processes, features, and devices are shown in block diagram form in order to avoid obscuring the description. In other instances, functional block diagrams and flow diagrams are shown to represent data and logic flows. The components of block diagrams and flow diagrams (e.g., modules, blocks, structures, devices, features, etc.) may be variously combined, separated, removed, reordered, and replaced in a manner other than as expressly described and depicted herein.

Reference in this specification to “one embodiment”, “an embodiment”, “other embodiments”, “one series of embodiments”, “some embodiments”, “various embodiments”, or the like means that a particular feature, design, structure, or characteristic described in connection with the embodiment is included in at least one embodiment of the disclosure. The appearances of, for example, the phrase “in one embodiment” or “in an embodiment” in various places in the specification are not necessarily all referring to the same embodiment, nor are separate or alternative embodiments mutually exclusive of other embodiments. Moreover, whether or not there is express reference to an “embodiment” or the like, various features are described, which may be variously combined and included in some embodiments, but also variously omitted in other embodiments. Similarly, various features are described that may be preferences or requirements for some embodiments, but not other embodiments.

The language used herein has been principally selected for readability and instructional purposes, and it may not have been selected to delineate or circumscribe the inventive subject matter. It is therefore intended that the scope of the invention be limited not by this detailed description, but rather by any claims that issue on an application based hereon. Accordingly, the disclosure of the embodiments of the invention is intended to be illustrative, but not limiting, of the scope of the invention, which is set forth in the following claims.

What is claimed is:

1. A computer-implemented method comprising:
training, by a computing system, a model to predict motion vectors for entities in video frames;
obtaining, by the computing system, a set of frames that correspond to a first video;
providing, by the computing system, the set of frames as input to the model; and
obtaining, by the computing system, a set of motion vectors for the set of frames from the model, wherein each motion vector describes a trajectory of at least one entity in the set of frames.

2. The computer-implemented method of claim 1, wherein an entity is one of a pixel, a block of pixels, an object, or a frame.

3. The computer-implemented method of claim 1, wherein training the model further comprises:
generating, by the computing system, training data to be used for training the model, the training data describing a plurality of entities and their respective pre-computed motion vectors; and
training, by the computing system, the model using the generated training data.

4. The computer-implemented method of claim 3, wherein generating the training data further comprises:
obtaining, by the computing system, a set of videos for training the model, each video having a set of frames;
determining, by the computing system, a set of respective motion vectors for one or more entities in the set of frames for each video; and
causing, by the computing system, data describing the one or more entities in the set of frames to be included in the training data as an example inputs and the corresponding motion vectors for the entities to be included in the training data as example outputs.

5. The computer-implemented method of claim 4, wherein the set of motion vectors are optimally determined using an exhaustive motion estimation algorithm.

6. The computer-implemented method of claim 3, wherein the entities correspond to objects, and wherein generating the training data further comprises:
obtaining, by the computing system, a set of videos for training the model, each video having a set of frames;
identifying, by the computing system, one or more objects in the set of frames for each video;
determining, by the computing system, a set of respective motion vectors for the one or more objects; and
causing, by the computing system, data describing the one or more objects in the set of frames to be included in the training data as an example inputs and the corresponding motion vectors for the objects to be included in the training data as example outputs.

7. The computer-implemented method of claim 3, the method further comprising:
providing, by the computing system, data describing one or more of the entities included in the training data as input to the model;
obtaining, by the computing system, one or more respective motion vectors for the entities from the model; and
determining, by the computing system, an inaccuracy in a motion vector determined by the model for at least one entity based at least in part on the respective pre-computed motion vector of the entity.

8. The computer-implemented method of claim 7, the method further comprising:
causing, by the computing system, the model to be retrained based at least in part on the inaccuracy.

9. The computer-implemented method of claim 1, wherein the entities correspond to frames, and wherein the motion vectors provide a general motion estimation of one or more frames.

10. The computer-implemented method of claim 9, the method further comprising:
providing, by the computing system, the general motion estimation to at least one motion estimation algorithm, wherein the motion estimation algorithm is configured to determine one or more motion vectors for the entities based at least in part on the general motion estimation.

11. A system comprising:
at least one processor; and
a memory storing instructions that, when executed by the at least one processor, cause the system to perform:
training a model to predict motion vectors for entities in video frames;
obtaining a set of frames that correspond to a first video;
providing the set of frames as input to the model; and
obtaining a set of motion vectors for the set of frames from the model, wherein each motion vector describes a trajectory of at least one entity in the set of frames.

12. The system of claim 11, wherein an entity is one of a pixel, a block of pixels, an object, or a frame.

13. The system of claim 11, wherein training the model further causes the system to perform:
generating training data to be used for training the model, the training data describing a plurality of entities and their respective pre-computed motion vectors; and
training the model using the generated training data.

14. The system of claim 13, wherein generating the training data further causes the system to perform:
obtaining a set of videos for training the model, each video having a set of frames;
determining a set of respective motion vectors for one or more entities in the set of frames for each video; and
causing data describing the one or more entities in the set of frames to be included in the training data as an example inputs and the corresponding motion vectors for the entities to be included in the training data as example outputs.

15. The system of claim 14, wherein the set of motion vectors are optimally determined using an exhaustive motion estimation algorithm.

16. A non-transitory computer-readable storage medium including instructions that, when executed by at least one processor of a computing system, cause the computing system to perform a method comprising:
training a model to predict motion vectors for entities in video frames;
obtaining a set of frames that correspond to a first video;
providing the set of frames as input to the model; and
obtaining a set of motion vectors for the set of frames from the model, wherein each motion vector describes a trajectory of at least one entity in the set of frames.

17. The non-transitory computer-readable storage medium of claim 16, wherein an entity is one of a pixel, a block of pixels, an object, or a frame.

18. The non-transitory computer-readable storage medium of claim 16, wherein training the model further causes the computing system to perform:
generating training data to be used for training the model, the training data describing a plurality of entities and their respective pre-computed motion vectors; and
training the model using the generated training data.

19. The non-transitory computer-readable storage medium of claim 18, wherein generating the training data further causes the computing system to perform:
obtaining a set of videos for training the model, each video having a set of frames;
determining a set of respective motion vectors for one or more entities in the set of frames for each video; and
causing data describing the one or more entities in the set of frames to be included in the training data as an example inputs and the corresponding motion vectors for the entities to be included in the training data as example outputs.

20. The non-transitory computer-readable storage medium of claim 19, wherein the set of motion vectors are optimally determined using an exhaustive motion estimation algorithm.
